(19) United States
(12) Patent Application Publication
(10) Pub. No.: US 2016/0232306 A1
(43) Pub. Date: Aug. 11, 2016

(54) PORTABLE SECURE HEALTH RECORD DEVICE AND SYSTEM FOR PATIENT-PROVIDER COMMUNICATION

(71) Applicant: AMRITA VISHWA VIDYAPEETHAM, Ettimadai, Coimbatore, Tamil Nadu (IN)

(72) Inventor: Pradeep Padmakshan ACHAN, Kollam (IN)

(21) Appl. No.: 14/917,609

(22) PCT Filed: Sep. 10, 2014
(86) PCT No.: PCT/IB14/64393

§ 371 Date: Mar. 9, 2016

(30) Foreign Application Priority Data
Sep. 10, 2013 (IN) 2665/DEL/2013

(51) Int. Cl. G06F 19/00; G06F 21/62

(52) U.S. Cl. CPC G06F 19/323; G06F 21/6245

(57) ABSTRACT

The present invention relates to portable secure health system. The portable secure health system provides communication of a person's personal health record between at least one patient and at least one service provider or among at least two service providers in a secure environment. The system comprises of unique portable personal health record (PHR) device (100), PHR Host (101) and patient provider communication system. The PHR device may be a physical storage device such as USB flash drive or SD card, or a virtual device entirely contained in a single file system file or cloud drive. The communication systems are also synchronized in a secure environment between PHR device (100) and patient provider communication system (102, 105).

### FIELD OF THE INVENTION

The present invention relates to the portable, secure, health record device and system for patient-provider communication.

### BACKGROUND OF THE INVENTION

Traditionally health care providers maintain the patient health records, and they do not supply a patient's health record to the patient for various reasons. In situations when a patient is being transferred to another health care provider and/or where there is a pressing need for her/his health record to be made available in a shareable or mobile format or secured manner to other health provider there are very a few health care providers willing to provide the patient's complete health record to the patient or to another health care provider. Even if the health care provider is willing to share the patient's health record, the underlying technology usually does not allow transfer of the records in a shareable, mobile, and secure manner. Thus the patient is, unable to track and monitor her health parameters, and take an informed healthcare decision, there is also an over-whelming requirement to protect a person's privacy.

“Health record” or “medical record” refers to a systematic documentation of the patients medical and health history. ‘Personal health records’ refers to ‘health record’ when it is owned and possessed by the person and which person can access without the intervention of a healthcare provider. These medical records include a variety of “notes” entered over time by healthcare professionals, recording observations and administration of drugs and therapies, orders for the administration of drugs and therapies, test results, x-rays, reports etc. Health records play an important role in modern health care and may take many forms such as recording in paper forms or on electronic storage systems.

Personal health record can be a life saver in an emergency situation. It can quickly provide personal vital information, patient family doctor contacts, allergies and medication in case of an emergency. Further it not only allows sharing of the information with the health care provider but also empowers the patient to be able to participate in his/her own health care by taking informed decisions.

Personal health record systems may be broadly classified into three categories namely paper based, centralized storage based and electronic storage device based. The paper based health record systems are low cost and reliable without need for a computer or any hardware or software. However they are difficult to update, share and maintain.

The second category of Personal Health Record system namely the centralized storage based patient health record system stores the patient's information on servers or associated data storage devices, which can be accessed over the internet (world-wide web), intranet, or similar information distribution system. Some of these centralized systems require the patient to carry or wear an electronic key that is used as an access key to the patient's centrally stored data. When it comes to the matter of accessing the personal health record outside the domain of a particular health care provider, Internet or the world-wide web is the most widely used platform. One of the disadvantages of centralized storage based health record systems is that the internet or the like, may not be available or may get disrupted in an emergency, for example, in 2004 after the Tsunami struck, internet access in the disaster affected areas was significantly disrupted. Another disadvantage of the centralized storage based systems is that, the centralized storage system is a fair game for hackers because of the large amount of personal information contained therein.

The third category of Personal Health Record system is the electronic device storage based system for storing personal health records (PHRs). Some electronic PHRs may include processors, software, and data storage, and can bring up the medical records for viewing or transfer them to another computer for viewing.

In the current state of art technology there are a number of disclosures including US 20090281836 which disclosed the USB devices, the US20090099864 which discloses the use of mobile phones and USRE42246 which discloses the use of servers to store information that is accessed using a card. The US patent application 20090281836 discloses medical personal record system which comprises the use of USB device and first and second softwares for implementing updates to the USB portable medical records database. A first software resident on the USB device auto-runs a resident database consisting of patient medical records data and also provides security and HMI functions. Second software resides on a business computer linked to the hospital medical records database for acquiring, sorting, and storing medical records on the USB device. A discharge service includes creating a USB portable medical records database for a patient being discharged, and may optionally include reviews of the records for compliance with medical and insurance standards. Only physician-dictated records are stored. Besides first time software installation is required for the patient data to be transferred from the USB to the host system. This disclosure includes a 256-bit encryption mechanism. The disadvantage of this system disclosed in this disclosure that it does not employ separate containers. Also, none of the present state of the art provides a system for structured patient-provider communication using a personal health record device.

The existing state-of-art in PHR systems and devices, including both vendor products and patents granted so far, has several drawbacks that result in limited range of use and less than ideal usefulness. For instance, the existing state of the art systems do not allow the patients or the users of the system to make a soft copy (virtual copy) of the records on the PHR device, place it in another systems such as another computer system, or in the cloud, especially when the other systems are not originally supported by the PHR vendor, while continuing to use the rest of the system functionality.

Further, in the state-of-art PHR device both the resident EHR software on the PHR device and the resident data is visible to users as a set of file-system artifacts consisting of files and directories leaving the system susceptible to hacking. Even if this resident data exists encrypted on the visible file-system preventing its undetectable malicious modification, it still can be easily tampered with and destroyed unbeknownst to the patient or the provider, rendering it unusable in an emergency situation.

Another drawback in that the state-of-the-art PHR devices such as flash drives launch directly into the operating system such as Windows, Linux and Mac through the automatic launching applications of said systems. However in light of recent security patches, these major operating systems viz. Windows, Linux, and Mac have disabled their automatic application-launch ability for removable, writable devices, as a result of which the auto-start feature of the resident EHR software on the device has ceased to work, forcing the user to search for and identify the resident EHR program name on the PHR device and launch it manually. Further, since the underlying filename of an application program tends to be a cryptic, alpha-numeric name instead of being a sufficiently descriptive user-friendly one, the user will always be prone to forgetting the EHR program name on her PHR device, resulting in a diminished user experience and annoyance at best, and precious time lost during emergency situations at worst.

Another drawback of the present PHR devices is that they do not provide any management of either the external device or its data contents. For example in a situation where memory of the PHR device is exhausted due to the large amount of patient's medical data collected over a period of time and PHR device with large storage memory is too expensive for user, he may end up carrying multiple PHR devices. In such scenario the present PHR device does not provide the mechanism to the user to ascertain which device instance has what data? Further the PHR device fails to provide the chance to the user to trim any unwanted data in order to save the precious data on to the device. If the patient wishes to keep multiple sets of PHR devices as her personal, local backup of her PHR data, then she has to depend on all her providers to make all such redundant backup copies for her gratis or even for a fee, assuming the providers are even interested in providing redundant backups to the patient.

Further all existing PHR device implementations need a major operating system (OS) such as Windows, Linux, or Mac to work and simply not work in the absence of these operating system. For instance where the nearby computer devices do not have these OS or where the OS is not readily available, or is available but is non-functional, or is found to be purposefully disabled by the computer's owner in some way so as to allow only explicitly authorized use of a USB flash drive, the PHR device would be rendered useless as patient or provider would be unable to access his medical record.

Presently PHR device implementation system does not allow co-existence of health records from multiple providers with the additional ability to track them both individually and together at the user's discretion. An example to illustrate the problems of such a situation is one where the patient or the physician may want to see health records from an arbitrary set of Providers, either individually, or collated together, or merged together. It is likely that severe discrepancies in some data may exist in the PHR device due to errors on part of one or more providers with no information as to where the error originated or how to detect these discrepancies.

Further in his life time person has availed the services of many health care providers and not every provider having the full health history of the patient in their proprietary EHR systems. Present PHR devices does not provide the facility to store all these information in structured manner.

Further existing PHR device are merely act as storage of the EMR data and does not alert the person about the medical services that he may requires based on the data that device or his age.

Further present state of art does not teach the convenient way of updating the PHR device. For instance when the patient goes to a provider facility for an elaborate set of medical tests, she must either wait at the facility or re-visit the provider at a later date when the tests are complete and results are ready to be saved to her PHR device. This can be inconvenient and gross waste of time for the patient. It can also be impossible if the patient needs to travel abroad or stay away for an extended period of time.

Further in an emergency situations especially in developing countries where patient from the remote areas are referred by village health care provider to some other health care provider in cities because of lack of medical facilities in the village. It may possible that the referred provider, may also decline accepting the patient based on possibly serious health condition after determining the patient's medical history from said patient and re-refer to some other health provider. This can prove fatal to the life of the patient as in process of referring lot of precious time is wasted.

Hence there is requirement of system which can directly obtain the PHR data of the patient directly from the referring provider without the immediate and physical mediation of the patient

### OBJECT OF THE INVENTION

In order to obviate the drawbacks of the existing state-of-the-art, the main object of the present invention is to provide a portable and secure personal health record device and a system for patient-provider communication using an electronic data storage device, devised to hold both patient-entered health data as well as provider-given medical records about the patient in separate containers.

Another object of the invention is to provide portable secure health record device having medical records software which does not require software installation on the host computer machine. It automatically loads on to the host machine and runs out of the electronic storage device. The host computer machine may be a stationary/fixed device or it may also be a mobile device.

Another object of the instant invention is the automatic self upgrade of the medical records software in a secure way whenever the host machine is connected to the Internet.

Yet another object of the present invention is to provide portable and Secure personal Health Record Device that uses encrypted database to store data.

Still another object of the present invention is to provide Portable Secure Health Record Device that runs on the fly encryption engine.

Yet still another object of the present invention is to provide method for updating the medical record information in the containers.

Another object of the present invention is to setup up secured communication channel for exchanging information with providers; and also for backing up encrypted data in the cloud, which is accessible to the USB owner with the keys to unlock the backed up data being available only with the owner or an authorized user.

Yet another object of the present invention is to provide system which has the capability to detect any updates to the patient's medical record information by any provider—via secure interaction with a cloud-based base station

### SUMMARY OF THE INVENTION

The present invention pertains to portable, secure and personal health record device and system for patient-provider communication. Personal health record device is data storage, communication and authentication device, architected to reside in a multitude of storage media such as electronic data storage media, mobile computing device or a virtual drive, that functions as an personal electronic medical record software engine and a patient-provider communication system.

The device data storage holds both patient-entered medical record data and provider-given medical records of the patients in separate containers. These containers have a mechanism to organize health information into information sets based on configurable parameters, allowing for information organization based on common use cases like the system of medical treatment such as Allopathy, Homeopathy and Ayurveda.

The device uses encrypted database to store data, encryption is achieved using an on-the-fly encryption engine. The device consists of a storage virtualization layer, that makes the device implementable using a multitude of storage drives like USB flashdrive, MicroSD or any other electronic device on which data can be stored including cloud-based storage systems. It does not need to have a processor, and can be easily implemented using a processor-driven device that includes storage like mobile phones, tablets and computers.

The EHR software embedded in the device, is designed to run directly out of device itself, independent of host machine's operating system, without requiring any software installation on to the host system. However system includes an Operating System Launcher service that can be installed on the host system, for additional capability to auto-start the device-resident EHR software. The EHR software handles patient's health and life related information such as patient encounters with providers, vitals, results from investigations, allergy and medication data, health trend line data, and patient's personal data including end of life preferences, legal documents and organ donor preferences.

The present invention also provides a secure method in which the device can be accessed to update the medical record information in the provider container. The steps include entering the provider's digital signatures and verifying the digital signature using verification engine. The device setup is also enabled to allow the providers to write to provider-container after receiving explicit authorization by the patient who owns the device.

Further the said system has the ability to detect any updates to the patient's medical record information, as and when updated by any provider via secure interaction with a cloud-based Synchronization Manager. The updation is done in a heuristic manner such that any discrepancy in the data to be updated vis a vis the historical data of the patient would alert the System of the discrepancy.

In another aspect of the invention which provides for secure environment for communication, the said system has embedded data structure and registry service to link the patient medical record to multiple and disparate software provider systems or to link patient to provider or to link provider to provider communication.

Accordingly the portable secure health system capable of providing communication of a person's personal health record between at least one patient and at least one service provider or among at least two service providers in a secure environment, wherein said system comprises at least one unique portable personal health record (PHR) device where such device may be a physical storage device such as USB flash drive or SD card or a virtual device entirely contained in a single file system file or cloud drive, PHR Host and patient provider communication system such that the communication between PHR device and patient provider communication system comprises of synchronization of data, said synchronization being completed in secure environment.

### BRIEF DESCRIPTION OF THE DRAWINGS

FIG. 1 depicts a block schematic representation illustrating the Portable Secure Health system and Device

FIG. 2 depicts a flowchart illustrating the method of accessing or deposit data in the encrypted data base of virtual device (102)

FIGS. 3a, 3b, 3c depicts the technical process of accessing patient data from the encrypted data base of PHR device in various scenarios.

FIG. 4. depicts the internal architecture of the PHR device of a specific embodiment of the present invention.

FIG. 5. depicts the about the synchronization system of the PHR system.

### DETAILED DESCRIPTION OF THE INVENTION

The present invention relates to the portable, secure, health record device and system for patient-provider communication.

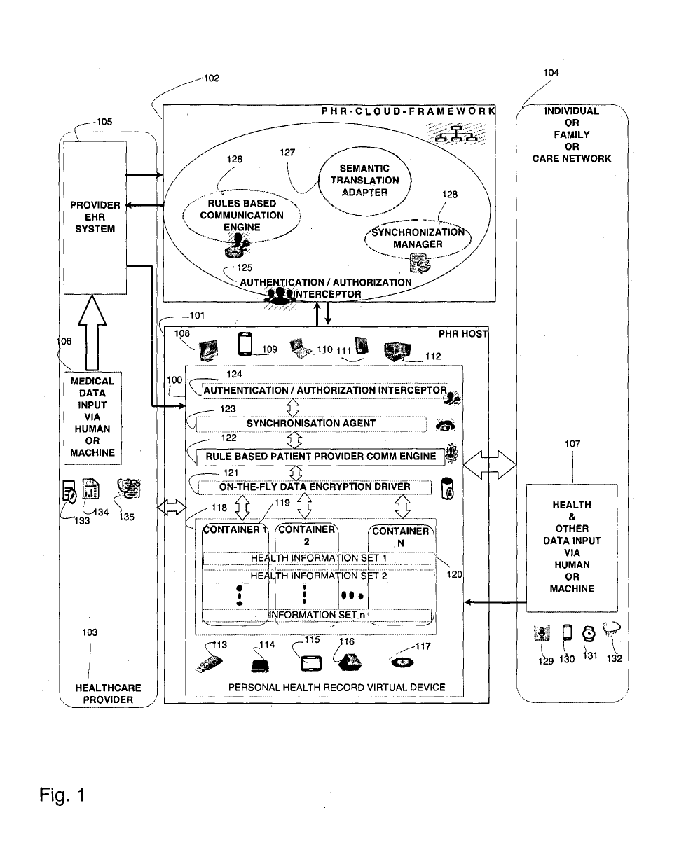

The Public Health Record (PHR) Device (100) and PHR Cloud Framework (102) in FIG. 1, are at the heart of the System disclosed in the present invention. The PHR device (100) loads automatically on the PHR host (101) and runs without any other software installations on the PHR host. However, the System includes an Operating System Launcher service that can be installed on the host system, for additional capability to auto-start the device-resident Electronic Health Record (EHR) software. The PHR host (101) includes any electronic device including computers (108), smart phones (109), laptops (110), tablets (111) or even a virtual machine (112).

PHR Device (100) is a smart device which may be virtual device, that runs its embedded software by loading itself on the PHR host (104). PHR device implementation is not dependent on the hardware. It is implementable on physical devices like flash drives (113), portable disk drives (114), and smart phones (115), as well as on virtual file storage and synchronization services like Google drive (116), Dropbox (117) etc. All the contents on PHR device (100) is encrypted using on-the-fly encryption driver (121), the implementation of which varies depending on whether the underlying storage is on a physical device or a virtual storage/synchronization service.

The PHR Cloud Framework (102) and PHR device (100) communicate with each other over Internet as well as over data exchange channels such as public network, private network, wired or wireless networks, Bluetooth networks etc. PHR Cloud Framework directly communicates with either the PHR device (100) or with the Electronic Health Record (EHR) system on the provider's end (105). Provider's EHR system may in turn get medical data inputs (106) like transcription (133), lab results (134), diagnostics (135) etc. On the other hand, at the patient's side, the health or other data inputs (107) can be given via speech input (129), smartphones (130), wearable devices such as pedometers (131), or even via smart contact lenses like the ones from Google (132). All of this data passes back and forth through the software stack of PHR device as well as PHR Cloud Framework.

The software stack on the PHR device as well as PHR Cloud Framework has their component counterparts on both ends. Authentication and Authorization interceptor on the PHR device (124) ensures that access to specific data is controlled based upon different levels of user's authentication and authorization.

For the purpose of this specification, the term “Rephrase” is a recursive acronym for: “Rephrase, [an] Encrypting PHR Application Storage Engine.” Further the terms “Rephrase Container”, “Rephrase Volume”, “Rephrase Root Data Container”, “Rephrase” are used interchangeably and corresponds to reference number (118) in FIG. 1. The Rephrase (118) is itself organized into different secure containers containing information such as Provider Given Medical Record (PGMR) (119), Patient entered medical record (PEMR) (119A) including separate container for wellness information, emergency information (119B) which is limited information accessible to public in case of emergency, and information container on the type of treatment (120). The terms “information container” and ‘information set” is used interchangeably.

The term “Rephrase Engine” refers to a engine that organizes the data storage in the Rephrase (118) into container sets (119, 120). The term “Rephrase Engine API”, “Rephrase API”, “API” or “Engine API” are interchangeably used and refer to the software resident on EHR used for accessing, collating or merging PHR data in the PHR device (100)

The container sets (119) are the logical representations of the data that is visible to the user who is accessing the data. These containers are fully encrypted using the On-the-fly encryption driver (121) thereby ensuring the integrity of the data therein. Access flags of these containers determine whether the containers are restricted-access or open-access. Primarily the restricted-access containers are classified into two—Provider Given Medical Record (PGMR) container (119A) and Patient Entered Medical Record (PEHR) container (119B). These containers are further subdivided into various containers depending upon the system of medicine e.g. Allopathic, Ayurvedic, and Homeopathic etc. The information sets in the information container (120) can be health related (Health Information Sets) or Lifestyle related (Lifestyle Information Sets). Health information sets contain data like Vitals, Allergies etc., whereas Lifestyle Information sets contain data like Fitness data, Legal will etc.

The actual communication between the Provider and the Patient occurs when the Rules based Patient Provider Communication Engine (122) on the PHR device communicates with its counterpart (126) on the PHR Cloud Framework. Integrity and confidentiality of the data is ensured by using the public/private keys and the digital signatures. Provider's EHR system can also directly communicate with the PHR device via the PHR host, without PHR Cloud Framework as a mediator.

This communication may happen synchronously as well as asynchronously. The Synchronization manager (128) in the PHR Cloud Framework takes care of ensuring that the communication is synchronized across patients and providers. By push and pull mechanisms, the Synchronization agent (123) on the PHR device and the Synchronization manager (128) orchestrate the flow of information smoothly across different provider domains and individual users who own the PHR device. In addition to synchronizing the data, Synchronization manager also takes care of managing the updates to PHR device's underlying software stack.

The semantic translation adapter (127) makes it possible to translate/transform various form of input data thereby ensuring the compatibility of data to its source and destination.

In this embodiment unless explicitly stated, the ‘user’ can mean either the patient, or the healthcare provider, or the physician. The term ‘Patient’ is used in a generic sense to refer to any person whose health records (both illness and wellness records) are stored and does not necessarily refer to a sick person.

The improved PHR device (102) in the present invention consists storage device that may also be a soft or virtual device instead of being limited to the prototypical, physical storage device such as a USB flash drive, SD Card, etc. This soft or virtual PHR device may exist within a regular file or residing on the file-system of a computing device such as a personal computer or mobile phone, or in a private or public cloud.

The soft or virtual PHR device can be mounted in a ‘loopback’ mode using tools and API provided by the operating-system and then used by any software application that understands the contents on the device and has appropriate operating-system granted privileges to access the contents. The device is password-protected which the client application me without providing password

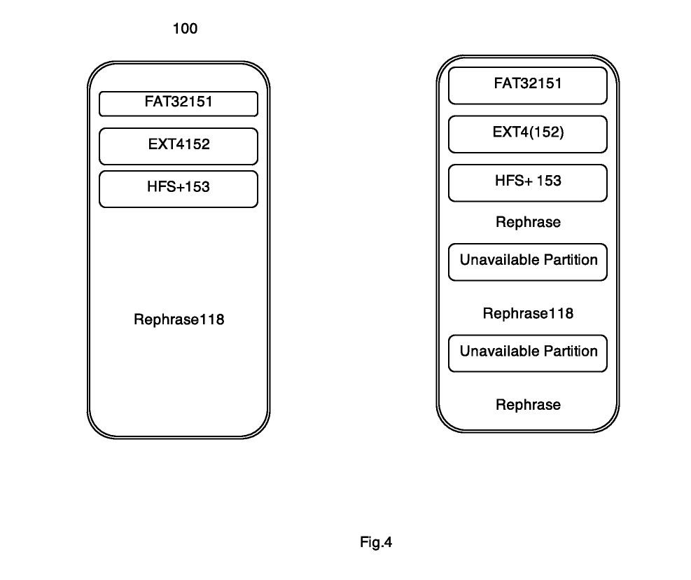

Referring now FIG. 4 depicts internal architecture the PHR device system which comprises of publicly visible partitions (151,152,153) and hidden encrypted Rephrase volume. The present device architected in a manner that it is compatible with different types of operating system. For this purpose the PHR Device whether physical or virtual, possesses at least three publicly visible primary partitions (151,152,153), with each partition dedicated to one of the three major operating-systems. For example, viz. Windows, FTA (151) Linux (152), and Mac (153), and each partition containing the native file-system of one of these three operating-systems. This allows the PHR device to be easily recognized by the operating-system specific applications and idiosyncrasies. Each of three publicly visible partitions (152,151,153) contains the EHR software and configuration files in a format understood by their host operating-system. In addition to these three publicly visible, operating-system specific partitions, there exists on the PHR device a hidden, encrypted Rephrase volume or container 119 in the raw or unpartitioned region of the PHR device that contains the PHR data.

The Rephrase container is a cross-platform data container. The PHR data in the Rephrase container is shared by the EHR software such that the patient is free to start the EHR software in a Windows computer (151), save some data on the PHR device, and then resume her session on another Linux (152) or Mac computer (153), with her previously entered PHR data is still available. This, together with the three operating-system specific partitions, makes the improved PHR device overall a portable PHR device.

Because the Rephrase container exists in the raw or unpartitioned space of the storage device, it remains invisible to the standard operating-system. provided disk-partitioning tools and other system software. The container also uses an on-the-fly-encryption engine to transfer data back and forth between itself and the resident EHR application. This design scheme helps keep the PHR data safe from the malicious users as well as malicious programs e.g., viruses, since any attacker will first need to figure out where exactly the actual PHR data in the unpartitioned region exists and then break through a 512-bit on-the-fly-encryption engine.

The Rephrase container (118) used in the improved PHR device has been purpose-built from ground up to support the secure storage needs of the EHR software in the present invention. The region of storage managed by this engine is referred to as a Rephrase “container” or “volume” in the present specification. The Rephrase container (118) can be created on any class or form-factor of a storage device including but not limited to USB flash drives, SD cards, micro SD cards, a regular file-system file on any storage device including one on a mobile phone functioning as a USB storage device or on cloud-based storage systems.

The Rephrase container used in the improved PHR device consists of an outermost (root) data container. It can span one or more, not necessarily contiguous, unpartitioned regions of a storage device, all the while remaining hidden from standard operating-system and disk-partitioning tools. Behaviorally, the Rephrase container transparently and intelligently self-tunes its internal storage structures for performance and storage as PHR data stored in it grows in size.

Inside of the Rephase root data container, (118) there may exist N logical, inner containers (N>=2) (119, 119A, 119B, 119C . . . 119n, 120). One of these containers holds the patient-entered data (119), emergency data in 119A and the rest the provider-given data, while the information container (120) contains information on the type of treatment. The Rephrase engine can also choose to intelligently coalesce all providers into a single, ‘provider’ container resulting in just two overall data containers. Regardless of the number of containers, they have strict logical boundaries. Through the use of APIs, Rephrase ensures that information does not cross container boundaries. However, Rephrase does allow for tagging and untagging operations such that information with same logical class or category can be organized into an information set spanning multiple containers.

The improved PHR system of the present invention provides a standard set of tags such as those based on systems of medicine (e.g. Ayurveda, Naturopathy, etc) or Vitals etc. Additionally, the user is allowed to create custom tags at her discretion. Rephrase provides an API to collate information sets spanning multiple containers thereby providing a collated view.

Rephrase also provides Access Control APIs to set Access Control Lists on each of the data containers.

The resident EHR software makes use of the Rephrase APIs for either collating or merging PHR data to build its user interface. For example, when a patient is lying in an Emergency Room and is unfit to provide her Access Control ID, then the resident EHR software interface in such a situation provides a view into the patient's PHR data from a Rephrase container designated for emergency public viewing. However, later when the same patient becomes conscious and is able to provide her Access Control ID, the resident EHR software shows the PHR data from additional containers using the information sets designated for emergency private viewing.

Rephrase provides mechanisms through the use of APIs for creation, expansion, deletion. For example, when a provider who is enlisted as a care provider for the patient and has the Access Control ID that identifies him as an Ayurvedic practitioner, the resident EHR application through its implementation of Rephrase APIs provides a view suitable for the practice of Ayurveda.

An information set (120) also makes it possible to define the PHR data as a collection of logical concepts such as allergies, symptoms, diagnosis, vitals etc and also provides for a mapping to containers in which each class of data will automatically go into. An information set also allows for storing of the PHR data in a single Rephrase container while making it available as separate entities in other containers, very much similar to soft-linking scheme in Unix-like file system. when a critical data like blood-pressure of the patient is updated in the Ayurveda container, it will automatically reflect in the Emergency container (119A). Because the underlying entity in question is the same, this data exchange happens in the reverse direction too, and also across multiple containers at once.

Older releases of major operating-systems (150) (such as Windows, Linux, and Mac) used to allow the automatic launching of applications from writable, removable storage devices such as USB flash drives. However, recent software patches to these operating-systems have disabled this feature due to security reasons. While nothing is needed to be done for those older releases of these operating-systems to automatically start the EHR software resident on the PHR device, for the recently patched operating-systems, the present invention installs an operating-system service that starts itself at boot-time and then continuously monitors for an insertion of, strictly, the improved PHR device, ignoring all other devices. Should the patient insert multiple PHR devices, an instance each of the resident EHR software is launched such that each instance talks to only its host PHR device. The number of such concurrently running EHR application instances is limited only by the number of ports in the computer and available memory.

In the another embodiment many PHR devices are chained when user require multiple PHR devices. As the storage memory of the PHR device can contain only a finite amount of data and exhaust over the passage of time. In the present invention, it is possible to chain additional PHR devices whenever more storage space to hold the PHR data is needed. This PHR device chain is such that only the first PHR device holds the three public partitions, with each of the rest of the linked PHR devices holding only a slice of the overall Rephrase container, coupled with only enough information about its preceding and succeeding links in the chain.

The PHR data is stored in the PHR device chain in strictly a chronological order from the first to the last link in the chain. Each link is identified with a human—as well as a machine-readable label. When viewing or managing of user PHR data, the improved EHR application, which is designed to handle chained PHR devices should there be any, may prompt the user to insert a specific link from the PHR device chain into the computer. During deletion or trimming of PHR data on the PHR device, any free storage ‘holes’ created in the process are not reused by the improved EHR application to store new PHR data in thereby disrupting the aforementioned chronological order of stored PHR data; the free storage holes are rather used only and only when a storage space compaction operation.

The improved EHR application in the present invention can, on its own, prompt the user of the generation of free storage holes on the PHR device following a data deletion or trimming operation. It can even provide a heuristics-based suggestion to the user to delete or trim her data, which may be later followed by the storage space compaction operation. The user too, at her own discretion, can check for the existing of such holes using the improved EHR software and initiate a free storage compaction operation if any are found to exist. As a corollary of this storage compaction operation, one or more trailing PHR devices in the PHR device chain may end up becoming completely empty. Such devices are removed from the PHR device chain by the improved EHR application and can be freely used for any general, data storage needs of the user within or outside the improved PHR system of the present invention.

The improved EHR application in the present invention allows the user to make an arbitrary number of backup copies of her PHR device chain. Each PHR device link in the new device chain is allowed to be an arbitrary-sized storage device without it having to be identical in size or even form-factor to its corresponding link the original PHR device chain. Consequently, the backed up copies of the original PHR device chain need not be of the same length, even including the possibility of all links being merged into a single PHR device large enough to hold the entire PHR data contained in the original PHR device chain.

Since the patient will see many healthcare providers in her lifetime, the improved PHR device of the present invention allows the user to save the PHR data from multiple providers on the same PHR device. The improved EHR application, then, allows the patient or the physician to view this data from multiple providers either individually, or together as collated or merged.

The healthcare providers, being human, can occasionally make mistakes in the course of their treatment of the patient and store incorrect data on the PHR device. The patient too can err when saving her own data in the PHR device. The PHR device provides heuristics-based alerts when its resident EHR application detect any serious discrepancies between data from two or more providers, or between the providers' data and that saved by the patient herself.

Further the improved EHR application allows the user to either temporarily or permanently ignore these alerts, or permanently store them as part of an event history or log, independent of the resolution, if any of the causative issues behind the alerts.

The PHR data stored on the PHR device is expected to keep growing with time. The patient can certainly choose to keep adding more and more devices to her PHR device chain as described earlier. However, not every piece of data may always hold the same relevance or importance to the patient. The improved EHR application in the present invention allows the patient to completely purge her PHR data from select providers, or to store a merged, summary value for some non-important data. For example, the patient may not find it worthwhile to keep her more than five-year old fever readings on her PHR device—she may either want to remove them all, or some of them, or keep their merged (say, average) value. Another example would be when the patient—either at her mere whim, or due to general loss of faith in one or more providers—decides to purge all her PHR data from such providers. Not all jurisdictions may legally require the patient to carry all of her PHR data on her PHR device chain. In case the patient has a backed up copy of her PHR device chain, she certainly may want to keep summarized values of any repetitive, space-hogging data on her primary PHR device chain.

The improved EHR application in the present invention provides heuristics-based soft suggestions to the patient for recommended checkups or consultations with her physician based on the PHR data from all her providers stored on her PHR device. A feat such as this would not be possible if the patient's health records were scattered over and locked into the proprietary EHR systems of her multiple providers.

Things can go wrong: users and software systems of providers can make mistakes. The improved PHR device of the present invention provides, for general troubleshooting and/or accountability-tracing, a non-purgeable and non-modifiable journal of all state mutations to the PHR Device arising from but not limited to inserts, updates and deletes by multiple providers, and data trimming, deletion, and updation by the patient herself.

There may arise a rare situation where the PHR device may have to be accessed in emergency but with no suitable computer with the supported operating-system available: the computer may simply be physically absent, or may be in a broken condition, or may be security-hardened to the extent that it would allow the connection of only explicitly authorized removable storage media. The improved PHR device of the present invention allows it to be connected to any computer that can boot itself from an externally-connected removable media (e.g., a USB flash drive) and provide a version of the resident EHR software that is substantially scaled down but still with a usable look & feel, and that can operate in a local or offline mode to merely allow access to patient's emergency data in the Emergency container (119A).

As is true with any software system, it is quite natural to expect that the vendor of the improved PHR device will make incremental improvements to the resident software and will want the owner of the device to avail these improvements. Instead of having the owner of the device download the patches and upgrades to the PHR device software from the vendor site and manually apply the same, or worse, have the owner visit the PHR vendor's service facility for the same, the improved PHR system in the present invention provides automatic, self-upgrade of the resident EHR software over the cloud.

Similar to software updates over the cloud, the improved PHR system of the present invention provides the convenience and power of having her PHR data on her device updated over the cloud with un-updated or un-synced data from her healthcare provider.

To enhance the general usability of the PHR device and resident EHR software and improve user productivity, the improved PHR system of the present invention provides various personalizations of not just the PHR data but also the resident EHR software. For example, the user may want to see PHR data only later than a certain date, or see PHR data only from select providers, etc. The system revolves around the individual patient who has the ability to hold vital pieces of information around his health and personal preferences whether physically with him/her or on the cloud or on a private data network, and can select at anytime who needs to be provided with what pieces of that information.

Typically, the individual visits several healthcare and alternate care facilities throughout the course of his or her life. Interactions with these consultants is be recorded either directly into this encrypted database (repository) of the PHR device (100) or stored in external provider systems in a variety of formats.

The starting point of a patient's data will be his or her profile which can be populated into the repository by the individual (201) directly via any interface mechanism. This will include parameter such as name, age, address, contact information, any medical conditions or allergies the patient is aware of, any special circumstances or abilities or disabilities. This data can also be obtained directly if previously entered into any 3^{rd} party system (204) via application interface connect points.

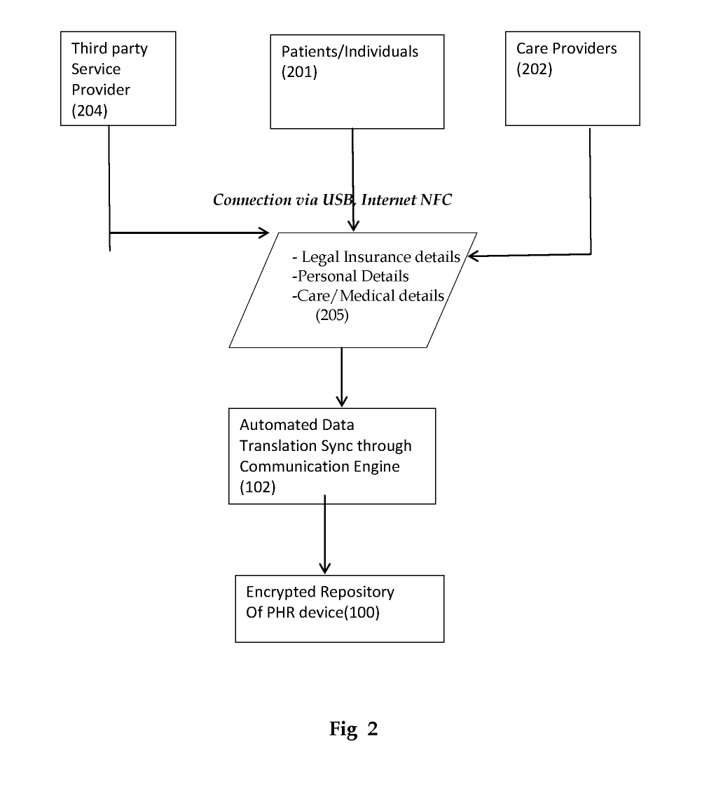

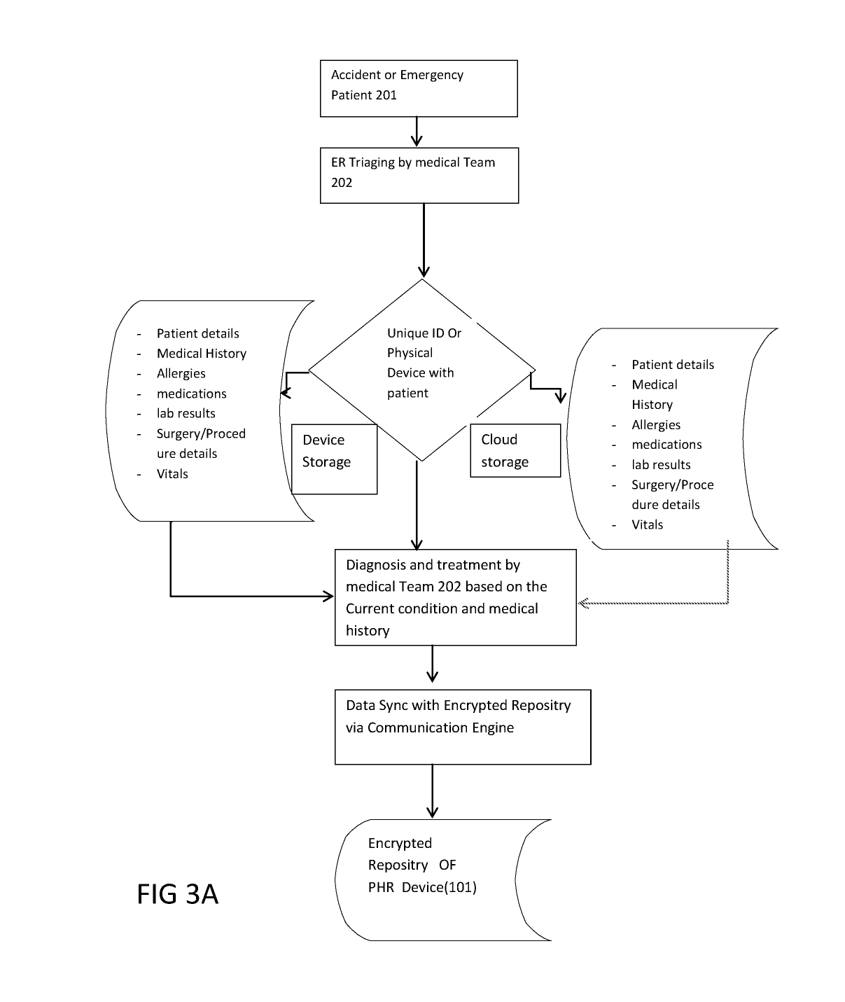

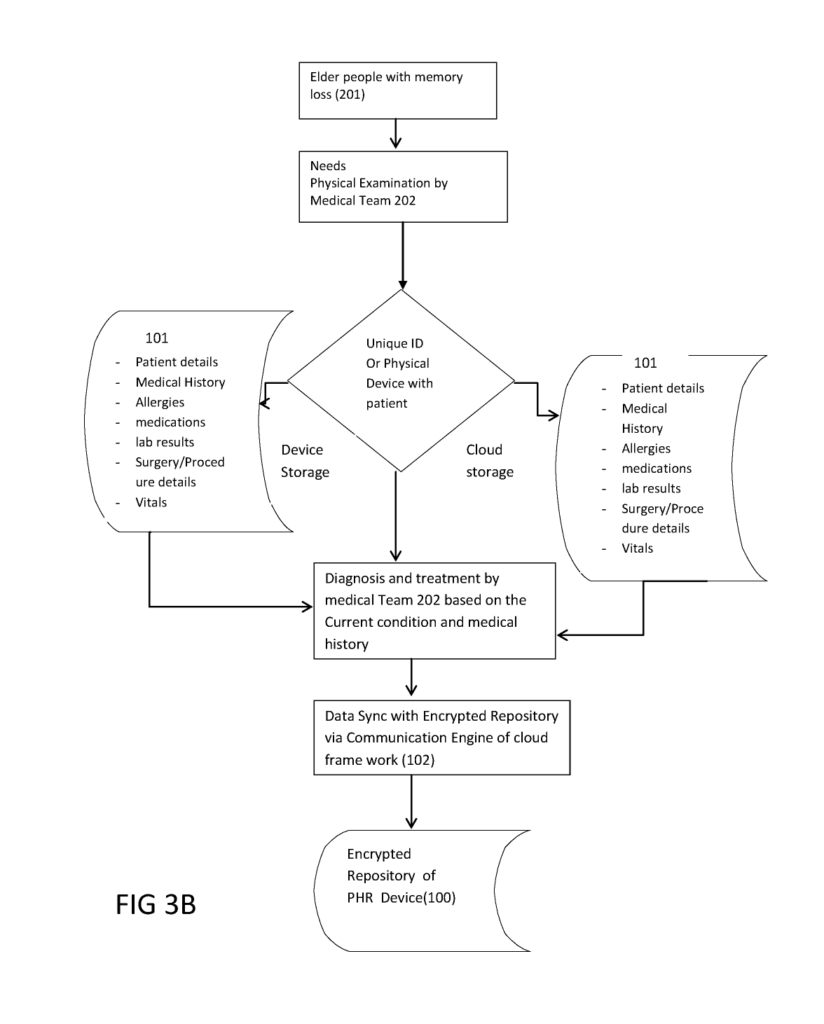

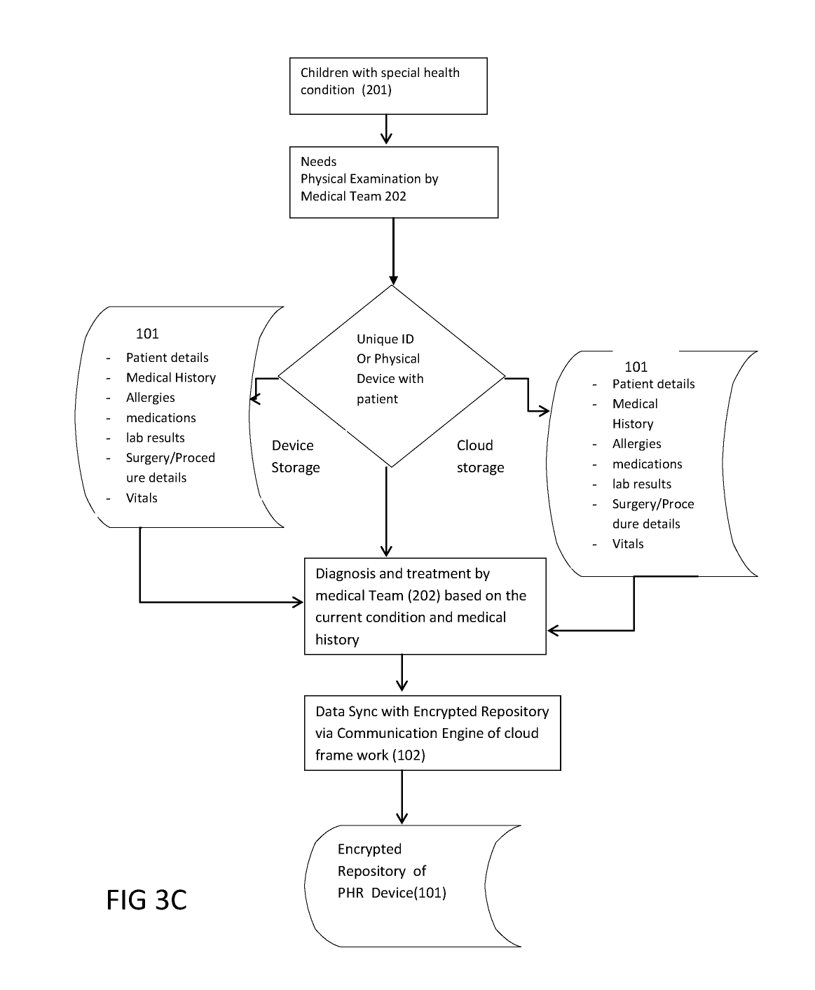

The process of the individual (101) visiting a chiropractic consultant. During the course of the consultation, the care provider (202) will capture several essential parameters, provide diagnostic recommendations, may recommend prescriptions and will provide a recovery plan including diet changes, exercises, and other regimens. The consultant may also provide informational material as well as refer the patient to any 3^{rd} party material. In addition the health professional may require the patient to undergo Lab or radiology investigations either one time or on a periodic basis. Information for these interactions will be fed into the System directly by the individual or through an interface mechanism between the 3^{rd} party provider system, the 3^{rd} party lab system to the communication engine of the PHR Cloud Framework (102). The type of information captured is reflected in FIG. 2, FIG. 3a and FIG. 3b. For any images—X-Rays, CT Scans, MRI's, etc, the multi-slice images can be transferred directly from the 3^{rd} party system into the secured encrypted repository over the API frameworks provided by the communications engine of the PHR Cloud Framework (102).

A similar dataflow occurs in patient interactions with other health care providers, nursing professionals as well as alternative treatment consultants. For any hospital wherein patient visits, the admitted patient's information will most likely be resident in that particular medical facility's database or Information system. Data can then be transferred to this “System” via interfacing with the APIs of the communication engine of the PHR Cloud Framework (102).

Access to the data stored in this encrypted repository of the PHR Device (101) is facilitated through the communications engine of the PHR Cloud Framework (102) to a variety of users based on their access levels to the data in encrypted containers.

As described in FIG. 2, the individual patients (201) can access all data through a multitude of interface devices. Data is also made available in the form of report which may contain status lists, analytical graphs, trend lines, contact information, etc. In a typical use case, patients (201) will use the device (107) to securely authenticate.

The access to the data, the care provider (202) will obtain the unique identifier from the patient—it may be in the form of a physical artifact or a storage device. With the appropriate unique ID and web URL, the care provider can access public containerized data directly through any browser based interface. This data will include patient profile, history of all medical and healthcare interactions, results from lab and radiology investigations along with DICOM images, current and ongoing medication, allergies or specific medical conditions, any specific care instructions, etc.

The 3^{rd} party service providers (204), data will be accessed either directly through the patient's storage device or through a unique identifier provided by the patient (201). Service Providers (203) will be able to import and export information relating to their domain such as insurance details, claims, legal wills and estate instructions, etc. Information will be edited and exchanged based on flexible and configurable rules set up by the individual (201) in the communications engine (102) allowing certain levels of access for these 3^{rd} party providers.

The present invention shall now be explained with accompanying Examples

### Emergency or Critical Care

As in FIG. 3a, 3b an accident victim or a patient in critical care is brought to a medical care facility. At that point the medical care provider (202) accesses the patient unique ID or physical device with the patient (201), and connects to the communication engine via any browser based interface. The communication engine will extract information relevant to the medical service provider. This information may include patient public profile, history of all medical and healthcare interactions, results from lab and radiology investigations along with DICOM images, current and ongoing medication, allergies or specific medical conditions, any specific care instructions, etc. The medical care provider will base his or her diagnosis and care plan based on this data and the patient's current condition. Any interactions or new investigations will be captured and synced back into the encrypted database of virtual PHR device (101) via the communication engine (102).

Children with Special Conditions or Special Needs

FIG. 3c illustrates another scenario in which a child (201) with a critical condition such as Asthma, or a child with special needs suddenly has an aggravated at his school or day care facility FIG. 3C. In the absence of traditional caregivers or parents being close to the scene, the child is brought to a medical center. The unique ID or physical storage with the child is then accessed by the medical provider (202). This information will contain special care plans, allergy information, and special instructions along with history of all medical and healthcare interactions, results from lab and radiology investigations along with DICOM images, current and ongoing medication. This information could be life saving in this circumstance. The medical care provider will base his or her diagnosis and care plan based on this data and the patient's current condition. Any interactions or new investigations will be captured and synced back into the encrypted database of the PHR device (101) via the communication engine 102 of the cloud framework (102).

### Rule-Based Communication and Translation Engine (ARCTE)

Rule-based Communication and Translation Engine (ARCTE) implements a communication system between provider and patient. Communication involves two ARCTE servers, one in the provider end and one in the cloud. One in the provider facility will have private addresses. The ARCTE server in the cloud will receive the communication message from PHR device. This is achieved through Application Processing Interface (API) calls and does not use regular email service. This ensures that no mail server ports are opened through the firewall for transmission. Entire transmission is achieved through the use of appropriate APIs.

For every person/patient who has a cloud account into ARCTE, communication for the Health Care Provider (recipient) is first placed into the cloud account of the patient themselves. The System in the cloud will analyze who the recipient of the communication is, ie. which hospital or provider the communication is intended to. If it is meant for a particular provider A, the communication is then dropped into the ARCTE inside the intranet of the hospital/provider. At the provider side, communication is integrated into the EHR software of the provider. Communication is displayed using a custom interface specifically designed to be integrated into the EHR software.

Similarly doctor can send back a response. This will reach to the hospital's ARCTE first. From there it will be routed to the communication server in the Cloud through the use of APIs. When the user is putting the device, it will automatically pull the communication intended for them, from the cloud.

For example, in a situation where the patient is discharged, but the documents such as discharge summary and some of the investigation reports are not ready yet, the hospital need not ask the patient to come back with the device to load the data into the personal health record device. Instead, hospital can simply send a secure communication to specialized communication format setup for the purpose so that when the patient connects the device to a computer which has internet, the latest information uploaded by the hospital is synced up with the patient record on the device automatically. A confirmation message is shown to the user to inform that some records from so and so hospital is ready for sync up. Once patient confirms, the device is automatically sync up.

Security is addressed by either direct address where no regular communication addresses are involved or by way of encrypted communication where there is a point to point encryption. Addresses are managed entirely by the ARCTE cloud end and ARCTE hospital end only; and are not known or published to any other 3^{rd} party systems. i.e. the transport and application layers are completely private. Multiple providers can participate in the cloud, system caters for each provider to have a separate logical domain of their own.

This type of communication interface with EHR is unique, for it allows the doctor to look at the EHR and in the same context communicate to the patient. Along with EHR records, this interfaces lets the doctor see the information in APHR device (only those the portion shared by patient through the communication through ARCTE can be seen) as well as manage communication with the patient.

Implementation is unique, because it is not an offline communication. Offline communication is not maintained in one place. Here, everything is integrated into the EHR. As long as access is available to the medical records, communication also can be seen, in the context of the EHR.

Also, the provider can send a clinical document; say a report, to the patient. Patient's medical record number is linked to the Personal Health Record device. Provider can send the document to the MRD number. It will automatically send it to the cloud. It will reach the device through the cloud, since the device id is linked to the medical record number.

Patient can share the information securely, by putting in the RCTE and then authorize certain other persons to view the information. When the other person authenticates himself and logins into the cloud application, they will see that certain information is being shared with them. On clicking on such a link, they will get the same interface as if the device has been inserted and the interface opened.

Different containers will enable to store all system related software (OS), clinical data, and personal data if any in separate containers. The clinical data container itself may further be partitioned into different containers, with one container containing Emergency care related data, one other container to store DICOM related data, and further partitions depending on the different functionalities.

This system has the capability to convert clinical data of different formats into the Consolidated Clinical Document Architecture C-CDA format.

The storage system is organized into at least three partitions on the basis of the type of data stored. For instance the storage may be based on a read-only partition, an encrypted partition for storing secure health records, and an open access partition for storing emergency information. The encrypted partition is accessible using a key to unlock and access the information. The partition holding the medical record will have at a minimum two containers named as patient-owned container and provider-owned container, but implementable to any number of containers based on additional distinctive roles.

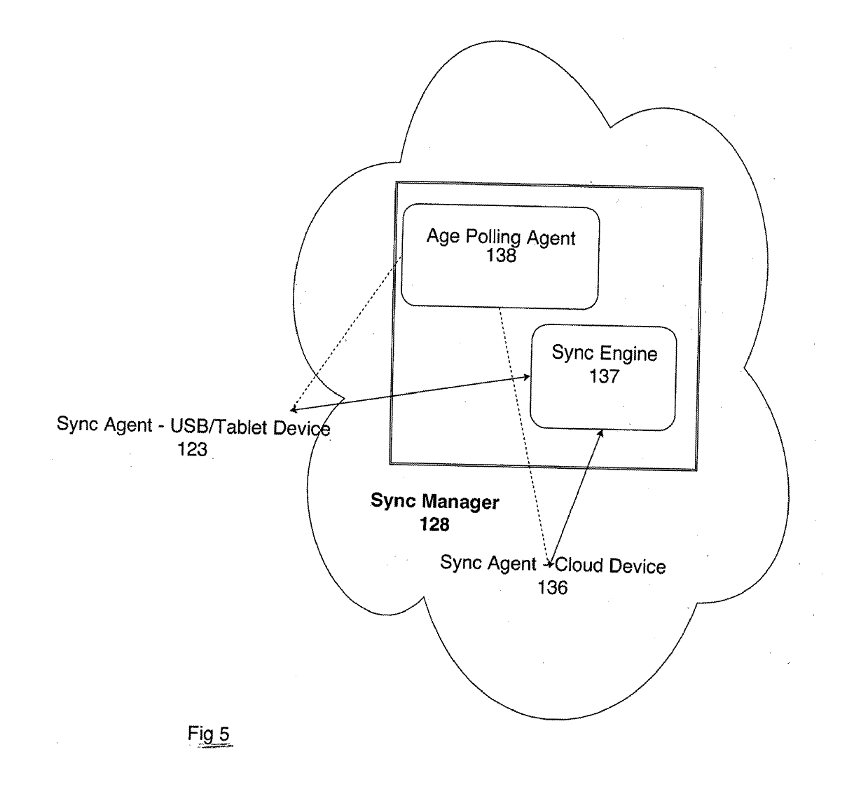

FIG. 5 illustrate the synchronization system in which there are multiple channels and multiple synchronous agents through which the data can get updated. The patient data may get updated by the Patient or by any of the Care-Providers. The data may get updated in the device first and then synchronized to cloud-PHR or vice-versa.

The synchronization Manager (SM) (128) ensures that the data synchronization is maintained across the Device and the cloud instance of the data. SM updates the device software data as well as the patient medical record data.

As illustrated in FIG. 5, The ‘Age Polling Agent’ (138) checks availability of latest version of data, Patient Data or Device Software, on both the cloud as well as the device whenever an Internet connection is available for establishing the cloud connectivity. When a latest version is detected the data sync procedure is completed. The Sync Engine (137) handles the data connections and the data encryption mechanisms for the synchronization.

The present invention employs embedded data structure takes advantage of the globally unique identifier of the device. Patient will typically have many patient identifiers by which his medical records are identified in various providers' respective EHR applications. Globally unique identifier of the device is used as the system key and main identifier of the patient's health record. This is linked to various secondary identifiers the patient have for different providers. A registry service, typically implemented in software, also serve the process of enrollment, duplicate detection and merging of identifiers. Embedded data structure for such device is presently implemented using Hashmaps.

We claim:

1. The portable secure health system capable of providing communication of a person's personal health record between at least one patient and at least one service provider or among at least two service providers in a secure environment, wherein said system comprises at least one unique portable personal health record (PHR) device (100), PHR Host (101) and patient provider communication system (102, 105) such that
said communication between PHR device (100) and patient provider communication system (102, 105) comprises of synchronization of data, said synchronization being completed in secure environment.

2. The portable secure health system as claimed in claim 1 wherein said system comprising of at least one unique portable personal health record (PHR) device (100), PHR Host (101) and patient provider communication system (102, 105), wherein
said PHR device (100) comprises of rule based communication engine, and at least one set of data storage, Rephrase container (118), to hold personal information, said PHR device being hosted on said PHR Host (101),
said provider communication system (102, 105) comprises of at least 1 Provider Communications System(s) capable of independent communication with said PHR device,
one said Provider communication system having at least one EHR (105) system at the provider capable of direct communication with PHR device, and
other said Provider communication system having at least one PHR cloud frame work (102), said PHR cloud frame work (102) comprising of Rule based communication engine (126) and synchronization manager (128), said PHR cloud frame work (102) being capable communicating directly with said PHR.

3. The portable secure health system as claimed in claim 2 wherein each said set of data storage, Rephrase container (118) in said PHR comprises of at least one each of personal data container (119) comprising of patient given medical record, emergency data container (119A) comprising of limited medical data accessible by public at large in emergency situation, provider given data container(s) (119B, 119C . . . 119n) and information container (120), comprising information on treatment method provided by said provider.

4. The portable secure health system as claimed in claim 1 wherein said portable personal health record (PHR) device (100) where such device may be a physical storage device such as USB flash drive or SD card; or a virtual device entirely contained in a single file system file or cloud drive

5. The portable secure health system as claimed in claim 1 wherein said synchronization of information between provider and PHR is selected from direct synchronization or remote communication, such that in the former the information on the said PHR device is capable of being updated directly, and in the latter the information on said PHR device is capable of being updated on connection with Cloud Framework.

6. The portable secure health system as claimed in claim 3 wherein said data storage Rephrase container (118) on said PHR device is encrypted by on-the-fly-encryption driver and data storage in a logical container based mechanism to organize health information into Information container (120) based on configurable parameters, allowing for, information organization based on classification like system of medical treatment

7. The portable secure health system as claimed in claim 2 wherein communication between said PHR device, said EHR system and said Cloud Framework is secured by Application Programming Interface (API) and is accessible with secure password, said secure password being selected from public keys, private keys and digital signature such that the said communication is achieved employing embedded data structure that takes advantage of the globally unique identifier of the device.

8. The portable secure health system as claimed in claim 7 wherein said globally unique identifier of said PHR device (100) is used as system key and main identifier of the patient's health record which is linked to various secondary identifiers the patient have for different providers.

9. The portable secure health system as claimed in claim 2 wherein said information comprises of medical data inputs (106) like transcription (133), lab results (134), diagnostics (135) from the health provider, each stored in information sets spanning at least one container (118).

10. The portable secure health system as claimed in claim 2, wherein said synchronization of information between provider and PHR is selected from direct synchronization or remote communication such that information on said PHR device is capable of being updated and synchronized with, transcript of the communication as claimed in claim 6 stored in the PHR device in a format capable of being displayed with the characteristics of the discussion

11. The portable secure health system as claimed in claim 2 wherein said data is stored on said PHR device and said EHR, and data on EHR capable of being accessed by said PHR device directly or through cloud highway of said PHR cloud frame work (102) such that neither case require a software installation on the host computer to which the said PHR device is attached.

12. The portable secure health system as claimed in claim 2 wherein said PHR Host is selected from computers, smartphones, laptops, tablets, virtual machine or any electronic medium such that it allows chaining of PHR Devices, possibly of varying storage capacities and storage types.
